(19) United States
(12) Patent Application Publication
(10) Pub. No.: US 2011/0140823 A1
(43) Pub. Date: Jun. 16, 2011

(54) TRANSFORMER MODULE

(75) Inventors: Chi-Kai Lin, Taoyuan Hsien (TW); Hua-Sheng Shih, Taoyuan Hsien (TW); Gang Zeng, Taoyuan Hsien (TW); Chang-Dong Cao, Taoyuan Hsien (TW); Xiao-Pei Wang, Taoyuan Hsien (TW)

(73) Assignee: DELTA ELECTRONICS, INC., Taoyuan Hsien (TW)

(21) Appl. No.: 12/912,396

(22) Filed: Oct. 26, 2010

(30) Foreign Application Priority Data
Dec. 15, 2009 (CN) 200910261447.3

(51) Int. Cl. H01F 27/02

(52) U.S. Cl. 336/90

(57) ABSTRACT

A transformer module includes at least one first casing, at least one second casing and at least one transformer. The first casing has a first receptacle. A protrusion structure is formed on an inner wall of the first receptacle. The second casing is accommodated within the first receptacle. The second casing includes plural winding terminals and a second receptacle. An angle of at least one outer-corner of the second casing is non-right angle so that the protrusion structure and the outer-corner define foolproof structures for limiting the install direction of the second case. The transformer is accommodated within the second receptacle. The transformer includes a magnetic core and at least one coil wound on the magnetic core. Both terminals of the coil are connected to respective winding terminals.

### FIELD OF THE INVENTION

The present invention relates to a transformer module, and more particularly to a transformer module with simplified fabricating process, small size and high yield.

### BACKGROUND OF THE INVENTION

Nowadays, a conventional transformer module includes a single casing and a single transformer. The transformer is accommodated within the casing. Due to that the limited number of transformer can be accommodated within the single casing, the performance of the transformer module are also restricted. Complying with the practical requirements, plural transformer modules must be mounted on a printed circuit board.

Generally, the plural transformer modules are mounted on the printed circuit board by a robotic arm. The robotic arm has a specific dimension. For preventing the robotic arm from damaging the installed transformer modules, every two adjacent transformer modules are separated from each other by a working space for receiving the robotic arm. Since the electronic devices are gradually developed toward miniaturization, the conventional method of mounting plural transformer modules is not feasible.

### SUMMARY OF THE INVENTION

It is an object of the present invention to provide a transformer module for accommodating and positioning plural electronic devices such as transformers.

Another object of the present invention provides a transformer module, in which the process of assembling the transformer module is simplified and the possibility of erroneously installing the transformer module is reduced.

A still object of the present invention provides a transformer module with small size and having additional effects of filtering, inductance and magnetic inducing.

A further object of the present invention provides a transformer module with reduced volume.

In accordance with an aspect of the present invention, the transformer module includes at least one first casing, at least one second casing and at least one transformer. The first casing has a first receptacle. A protrusion structure is formed on an inner wall of the first receptacle. The second casing is accommodated within the first receptacle. The second casing includes plural winding terminals and at least one second receptacle. An angle of at least one outer-corner of the second casing is non-right angle so that the protrusion structure and the outer-corner define a foolproof structure for limiting the install direction of the second case. The transformer is accommodated within the second receptacle. The transformer includes at least one magnetic core and at least one coil wound on the magnetic core. Both terminals of the coil are connected to respective winding terminals. In an embodiment, the protrusion structure and the outer-corner are complementary structures, and the outer-corner can be polygon-shaped or arc-shaped.

In an embodiment, the coil includes two or more than two conductive wires.

In an embodiment, at least two terminals of the conductive wires are twisted together or combined as a contact point.

In an embodiment, the conductive wires are wound on the magnetic core in a parallel winding manner or in a twisted winding manner.

In an embodiment, at least two of the conductive wires are partially twisted together.

In an embodiment, one of the conductive wires has a middle segment to be twisted together or combined as a contact point.

In an embodiment, the winding terminals and the second casing are made of same material.

In an embodiment, the winding terminals are made of an electrically-conductive material.

In an embodiment, the winding terminals are surface mount device (SMD) pins.

In an embodiment, the second casing is coupled to a printed circuit board by the winding terminals.

In an embodiment, the transformer module further includes a printed circuit board, and the second casing is enclosed by the first casing and the printed circuit board.

In an embodiment, a filling material is filled into the first receptacle and/or the second receptacle.

In an embodiment, the filling material includes a binding material, an insulting material, a magnetic material, a plastic material or air.

In an embodiment, two or more than two second casings are accommodated within the first receptacle.

In an embodiment, the winding terminals and the second casing are made of different material.

In an embodiment, the winding terminal or the second casing is made of plastic material or an electrical insulating material.

In an embodiment, the winding terminals are made of a metallic material or a conductive polymeric material, and the second casing is made of plastic material.

Since the protrusion structure of the first casing and the outer-corner of the second casing define the foolproof structures for limiting the install direction of the second casing and facilitating positioning the second casing within the first receptacle, the process of assembling the transformer module is simplified and the possibility of erroneously installing the transformer module is reduced.

In addition, since three or more than three conductive wires are wound on the single magnetic core, the size of the transformer is further reduced and the transformer can provide additional effects of filtering, inductance or magnetic inducing. Since plural transformers are included in the same transformer module, the overall size of the transformer module is reduced. Moreover, since the winding terminals are surface mount device (SMD) pins, the overall size of the transformer module can be further reduced.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is an exploded view illustrating a transformer module according to an embodiment of the present invention; and

FIGS. 2-6 schematically illustrate several exemplary structures of winding the coil on the transformer.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

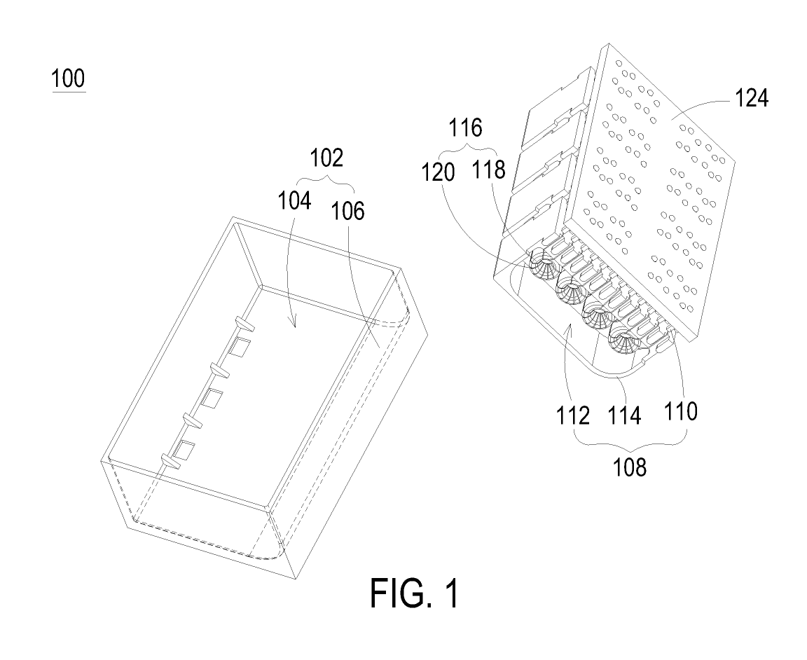

FIG. 1 is an exploded view illustrating a transformer module according to an embodiment of the present invention. As shown in FIG. 1, the transformer module 100 includes at least one first casing 102, at least one second casing 108 and at least one transformer 116. The first casing 102 includes at least one first receptacle 104. A protrusion structure 106 is formed on an inner wall of the first receptacle 104. In this embodiment, the transformer module 100 includes four second casings 108, and each of the second casings 108 contains four transformers 116. The dimension of the first receptacle 104 has been elaborately determined in order to accommodate the four second casings 108. According to the practical requirements, the transformer module 100 includes two, three, four or more than four second casings 108. Depending on the number of the second casings 108, the dimension of the first receptacle 104 are varied.

Please refer to FIG. 1 again. The second casings 108 are accommodated within the first receptacle 104. Each of the second casings 108 includes plural winding terminals 110 and a second receptacle 112. The opening direction of the first receptacle 104 is different from that of the second receptacle 112. An angle of at least one outer-corner 114 of the second casing 108 is non-right angle. Since the protrusion structure 106 and outer-corner 114 are complementary structures, the protrusion structure 106 and the outer-corner 114 can be considered as foolproof structures for limiting the install direction of second casing 108 and facilitating positioning the second casing 108 within the first receptacle 104. It is noted that the profiles of the protrusion structure 106 and the outer-corner 114 are not restricted as long as they are complementary structures. In an embodiment, the outer-corner 114 can be polygon-shaped or arc-shaped.

The winding terminal 110 and the second casing 108 can be made of same material or different material. The winding terminal 110 and the second casing 108 are made of plastic material or electrical insulating material. Alternatively, the winding terminal 110 is made of an electrically-conductive material (e.g. a metallic material or a conductive polymeric material), and the second casing 108 is made of an electrical insulating material (e.g. a plastic material). The winding terminal 110 is surface mount device (SMD) pin. In other words, the winding terminals 110 are mounted on a printed circuit board 124 according to a surface mount technology (SMT).

The transformers 116 are accommodated within the second casing 108. Each of the transformers 116 includes at least one magnetic core 118 and at least one coil 120. The coil 120 is wound on the magnetic core 118. Two terminals are coupled to corresponding winding terminals 110.

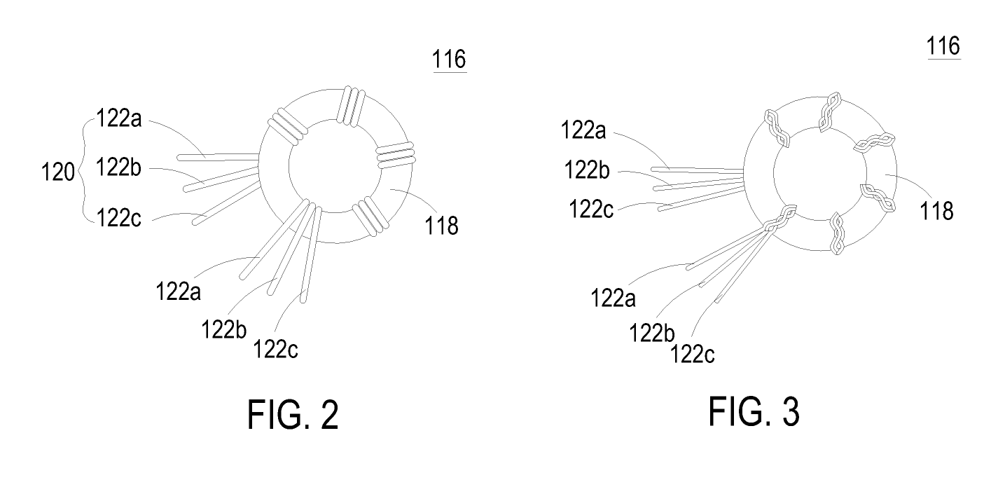

The coil 120 includes one, two, three, four, five or more than five conductive wires. Hereinafter, several exemplary winding structures of winding the coil 120 on the transformer 116 will be illustrated with reference to FIGS. 2-6. For clarification, the coil 120 having three conductive wires is illustrated.

As shown in FIG. 2, the transformer 116 includes a magnetic core 118 and three conductive wires 122a, 122b and 122c. In this embodiment, these three conductive wires 122a, 122b and 122c are wound on the magnetic core 118 in a parallel winding manner. The terminals of the conductive wires 122a, 122b and 122c are connected to respective winding terminals 110.

As shown in FIG. 3, the transformer 116 includes a magnetic core 118 and three conductive wires 122a, 122b and 122c. In this embodiment, these three conductive wires 122a, 122b and 122c are wound on the magnetic core 118 in a twisted winding manner, but the terminals of the conductive wires 122a, 122b and 122c are not twisted.

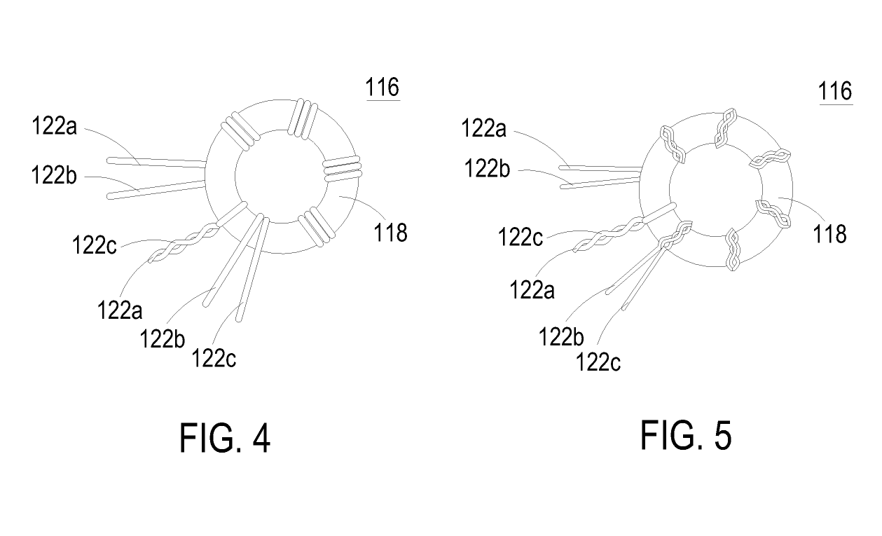

As shown in FIG. 4, the transformer 116 includes a magnetic core 118 and three conductive wires 122a, 122b and 122c. In this embodiment, these three conductive wires 122a, 122b and 122c are wound on the magnetic core 118 in a parallel winding manner, but the terminals of the conductive wires 122a and 122c are twisted together or combined as a contact point.

As shown in FIG. 5, the transformer 116 includes a magnetic core 118 and three conductive wires 122a, 122b and 122c. In this embodiment, these three conductive wires 122a, 122b and 122c are wound on the magnetic core 118 in a twisted winding manner, and the terminals of the conductive wires 122a and 122c are twisted together or combined as a contact point.

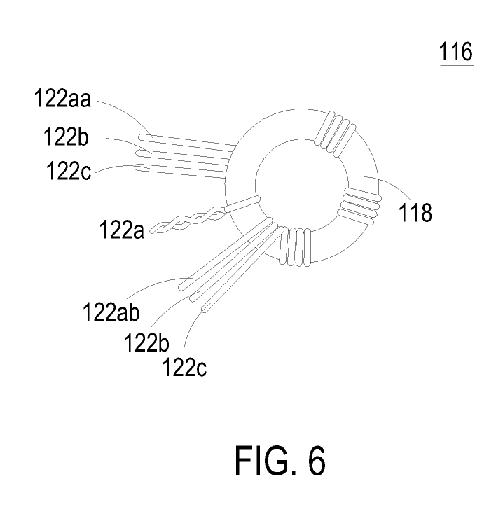

As shown in FIG. 6, the transformer 116 includes a magnetic core 118 and three conductive wires 122a, 122b and 122c. A middle segment of the conductive wire 122a is drawn to be served as a terminal, and twisted together or combined as a contact point. Then, these three conductive wires 122a, 122b and 122c are wound on the magnetic core 118 in a parallel winding manner (or a twisted winding manner). The other two terminals 122aa and 122ab of the conductive wire 122a and the terminals of the conductive wires 122b and 122c are not twisted.

When the coil 120 includes three or more than three conductive wires, portion of the conductive wires are wound on the magnetic core 118 in a twisted winding manner and portion of the conductive wires are wound on the magnetic core 118 in a parallel winding manner. In an embodiment, the coil 120 includes three conductive wires. Two of the conductive wires are wound on the magnetic core 118 in a twisted winding manner, and the twisted conductive wires and the reminding conductive wire are wound on the magnetic core 118 in a parallel winding manner.

Please refer to FIG. 1 again. After the winding terminal 110 are mounted on a printed circuit board 124, the second casing 108 is coupled to the printed circuit board 124. After the second casing 108 and the printed circuit board 124 are combined with the first receptacle 104, the second casing 108 is enclosed by the first casing 102 and the printed circuit board 124.

Moreover, the transformer module 100 further includes a filling material (not shown). The filling material can be filled into the first receptacle 104 and/or the second receptacle 112. An example of the filling material includes but is not limited to a binding material, an insulting material, a magnetic material, a plastic material or air.

From the above description, plural electronic devices such as transformers can be simply accommodated and positioned within the second casing and the first casing via a first receptacle having an opening direction different from that of second receptacle of the second casing. Since the protrusion structure of the first casing and the outer-corner of the second casing define the foolproof structures for limiting the install direction of the second casing and facilitating positioning the second casing within the first receptacle, the process of assembling the transformer module is simplified and the possibility of erroneously installing the transformer module is reduced.

In addition, since three or more than three conductive wires are wound on the single magnetic core, the size of the transformer is further reduced and the transformer can provide additional effects of filtering, inductance or magnetic inducing. Since plural transformers are included in the same transformer module, the overall size of the transformer module is reduced. Moreover, since the winding terminals are surface mount device (SMD) pins, the overall size of the transformer module can be further reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer module comprising:
at least one first casing having a first receptacle;
at least one second casing accommodated within said first receptacle, wherein said second casing comprises plural winding terminals and a second receptacle, and an opening direction of said first receptacle is different from that of said second receptacle; and
at least one transformer accommodated within said second receptacle, wherein said transformer comprises at least one magnetic core and at least one coil wound on said magnetic core, and both terminals of said coil are connected to respective winding terminals.

2. The transformer module according to claim 1, wherein said first receptacle has a protrusion structure on an inner wall thereof and an angle of at least one outer-corner of said second casing is non-right angle so that said protrusion structure and said outer-corner define foolproof structures for limiting the install direction of said second case.

3. The transformer module according to claim 2, wherein said protrusion structure and said outer-corner are complementary structures, and said outer-corner is polygon-shaped or arc-shaped.

4. The transformer module according to claim 1, wherein said coil comprises two or more than two conductive wires.

5. The transformer module according to claim 4, wherein at least two terminals of said conductive wires are twisted together or combined as a contact point.

6. The transformer module according to claim 4, wherein said conductive wires are wound on said magnetic core in a parallel winding manner or in a twisted winding manner.

7. The transformer module according to claim 4, wherein at least two of said conductive wires are partially twisted together.

8. The transformer module according to claim 4, wherein one of said conductive wires has a middle segment to be twisted together or combined as a contact point.

9. The transformer module according to claim 1, wherein said winding terminals and said second casing are made of same material.

10. The transformer module according to claim 1, wherein said winding terminals are made of an electrically-conductive material.

11. The transformer module according to claim 1, wherein said winding terminals are surface mount device (SMD) pins.

12. The transformer module according to claim 1, wherein said second casing is coupled to a printed circuit board by said winding terminals.

13. The transformer module according to claim 1, further comprising a printed circuit board, and said second casing being enclosed by said first casing and said printed circuit board.

14. The transformer module according to claim 1, further comprising a filling material filled into said first receptacle and/or said second receptacle.

15. The transformer module according to claim 14, wherein said filling material comprises a binding material, an insulting material, a magnetic material, a plastic material or air.

16. The transformer module according to claim 1, wherein two or more than two second casings are accommodated within said first receptacle.

17. The transformer module according to claim 1, wherein said winding terminals and said second casing are made of different material.

18. The transformer module according to claim 1, wherein said winding terminals or said second casing is made of plastic material or an electrical insulating material.

19. The transformer module according to claim 1, wherein said winding terminals are made of a metallic material or a conductive polymeric material, and said second casing is made of plastic material.
